(19) United States
(12) Patent Application Publication
(10) Pub. No.: US 2019/0299878 A1
(43) Pub. Date: Oct. 3, 2019

(54) REAR VIEW CAMERA SYSTEM

(71) Applicant: AISIN TECHNICAL CENTER OF AMERICA, INC., Northville, MI (US)

(72) Inventors: Yasuaki Nishio, Novi, MI (US); Yasuhito Noguchi, Kariya (JP)

(73) Assignee: AISIN TECHNICAL CENTER OF AMERICA, INC., Northville, MI (US)

(21) Appl. No.: 15/941,913

(22) Filed: Mar. 30, 2018

(51) Int. Cl. B60R 11/04; B60Q 1/24; H04N 5/232; H04N 5/235; H04N 5/445

(52) U.S. Cl. CPC B60R 11/04; B60Q 1/24; H04N 5/2328; B60R 2011/004; H04N 5/44591; H04N 5/44504; H04N 5/2354

(57) ABSTRACT

A camera system for a vehicle including a camera attached to a door of the vehicle to provide a rear field of view of the vehicle, the camera being articulable between an opened position and a closed position; an actuator affixed to the camera to rotate the camera; a position sensor that detects a position of the door between the opened position and the closed position; and an electrical control unit configured to operate the camera actuator based on the position detected by the position sensor such that the rear field of view is substantially directed in a horizontal direction to provide an unobstructed rear field of view when the door is articulated.

### BACKGROUND

### Field of the Disclosure

The present disclosure relates to rear view camera systems and/or video systems for vehicle.

### Description of the Related Art

Maneuvering a vehicle can be complicated and cumbersome. Notably, when the vehicle requires displacements in the rear direction and/or the dimensions of the vehicle are large, such as in the case of pick-up trucks, blind spots may be present.

To this end, conventional rear view camera systems that rely on capturing and displaying time series images of back and/or angle views of the vehicle have been implemented.

Though such conventional rear view systems have been widely used, they present important drawbacks. Notably, cargo placed on the vehicle can partially or completely obstruct the rear field of view of the camera and render the conventional rear view camera system inefficient.

Thus, a back-up camera system of a vehicle that enhances visibility and maneuverability when a cargo is carried by the vehicle is desired.

### SUMMARY

Accordingly, the object of the present disclosure is to provide a rear view camera system for a vehicle that displays a rear field of view of the vehicle without being blocked by a cargo carried by the vehicle as well as visual guides that outlines the boundaries and the terminal extremities of the cargo. In addition, the disclosed rear view camera system provides light signals that alert other drivers and/or pedestrians of the presence of the cargo.

In one non-limiting illustrative example, a camera system for vehicle is presented. The camera system includes a camera unit affixed to a door of vehicle articulable between an opened position and a closed position, the camera unit including a camera to provide a rear field of view of the vehicle, an actuator affixed to the camera to rotate the camera, and a position sensor to provide position signals commensurate with a position of the door between the opened position and the closed position, a light unit that surrounds the camera unit, and an electrical control unit configured to receive the position signals, provide light actuation signals to the light unit based on the position signals such light is projected on a road surface when the door is in the opened position, and provide actuation signals to the camera actuator based on the position signals such that the rear field of view is substantially directed in an horizontal direction to provide an unobstructed rear field of view of the vehicle whether the door is the opened position or the closed position.

In another non-limiting illustrative example, a camera system for vehicle is presented. The camera system includes a camera unit affixed to a door of vehicle articulable between an opened position and a closed position, the camera unit including a camera to provide a rear field of view of the vehicle, an actuator affixed to the camera to rotate the camera, and a position sensor to provide position signals commensurate with a position of the door between the opened position and the closed position, a light unit that surrounds the camera unit, and an electrical control unit configured to receive the position signals, provide light actuation signals to the light unit based on the position signals such light is projected on a road surface when the door is in the opened position, and provide actuation signals to the camera actuator based on the position signals such that the rear field of view is substantially directed in an horizontal direction to provide an unobstructed rear field of view of the vehicle whether the door is the opened position or the closed position.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A is a perspective view of a vehicle in an unloaded state, according to certain aspects of the disclosure;

FIG. 1B is a perspective view of the vehicle in a loaded state, according to certain aspects of the disclosure;

FIG. 1C is a perspective view of an rear view camera system of the vehicle when the vehicle is in the unloaded state, according to certain aspects of the disclosure;

FIG. 1D is a perspective view of the rear view camera system when the vehicle is in the loaded state, according to certain aspects of the disclosure;

FIG. 2 is an exploded view of a camera unit of the rear view camera system, according to certain aspects of the disclosure;

FIG. 3 is a side view of the vehicle with a tag of the rear view camera system in a horizontal position, according to certain aspects of the disclosure;

FIG. 4A is a perspective view of a light unit of the rear view camera system, according to certain aspects of the disclosure;

FIG. 4B is an exploded view of a light unit of the rear view camera system, according to certain aspects of the disclosure;

FIG. 5 is schematic diagram of the rear view camera system, according to certain aspects of the disclosure;

FIG. 6 is a chart flow of a method for operating the rear view camera system, according to certain aspects of the disclosure; and

FIG. 7 is a schematic view of a hardware diagram of an electrical control unit of the rear view camera system, according to certain aspects of the disclosure.

### DETAILED DESCRIPTION

All publications, patent applications, patents, and other references mentioned herein are incorporated by reference in their entirety. Further, the materials, methods, and examples discussed herein are illustrative only and are not intended to be limiting.

In the drawings, like reference numerals designate identical or corresponding parts throughout the several views. Further, as used herein, the words “a”, “an”, and the like include a meaning of “one or more”, unless stated otherwise. The drawings are generally drawn not to scale unless specified otherwise or illustrating schematic structures or flowcharts.

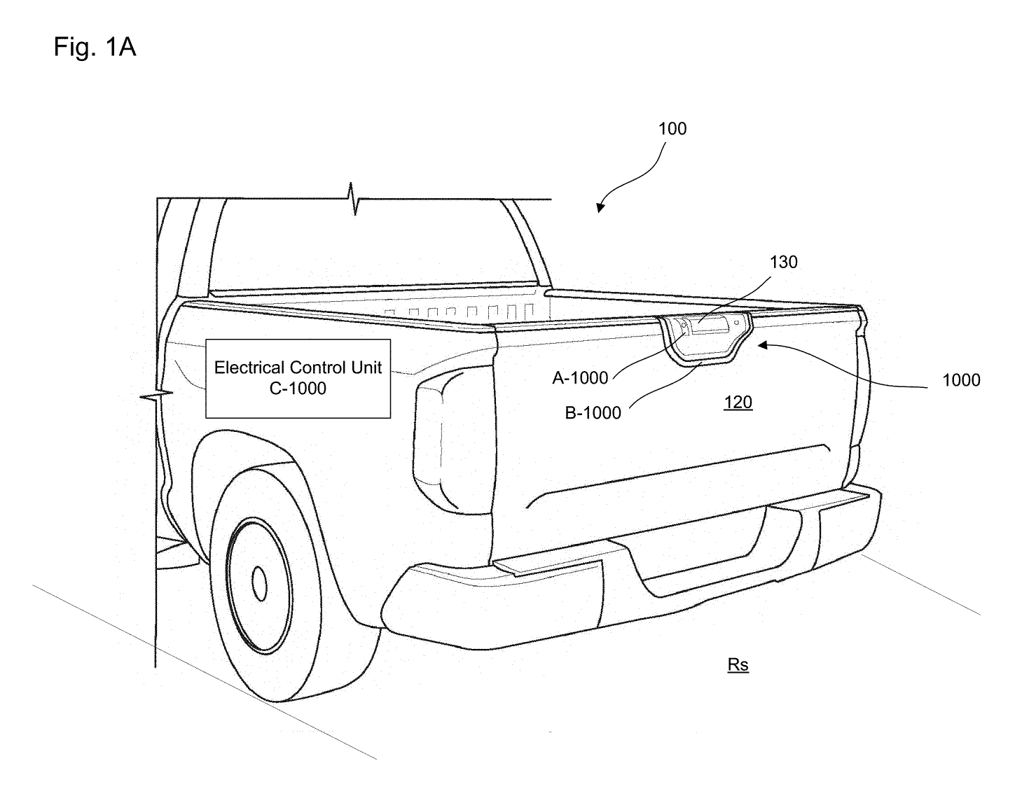

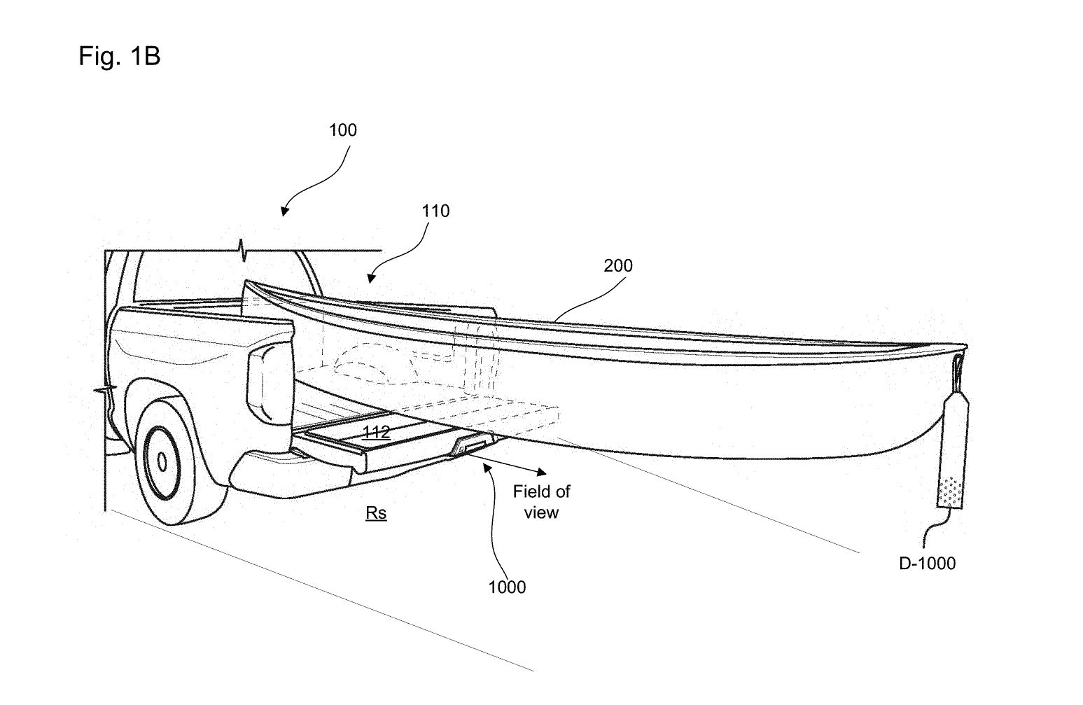

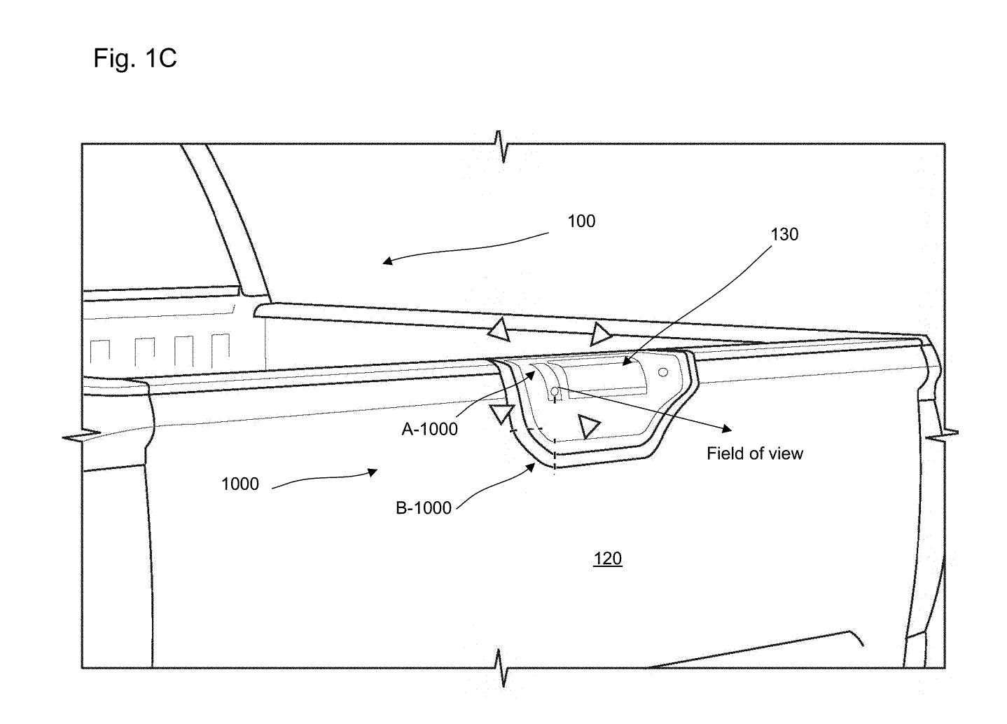

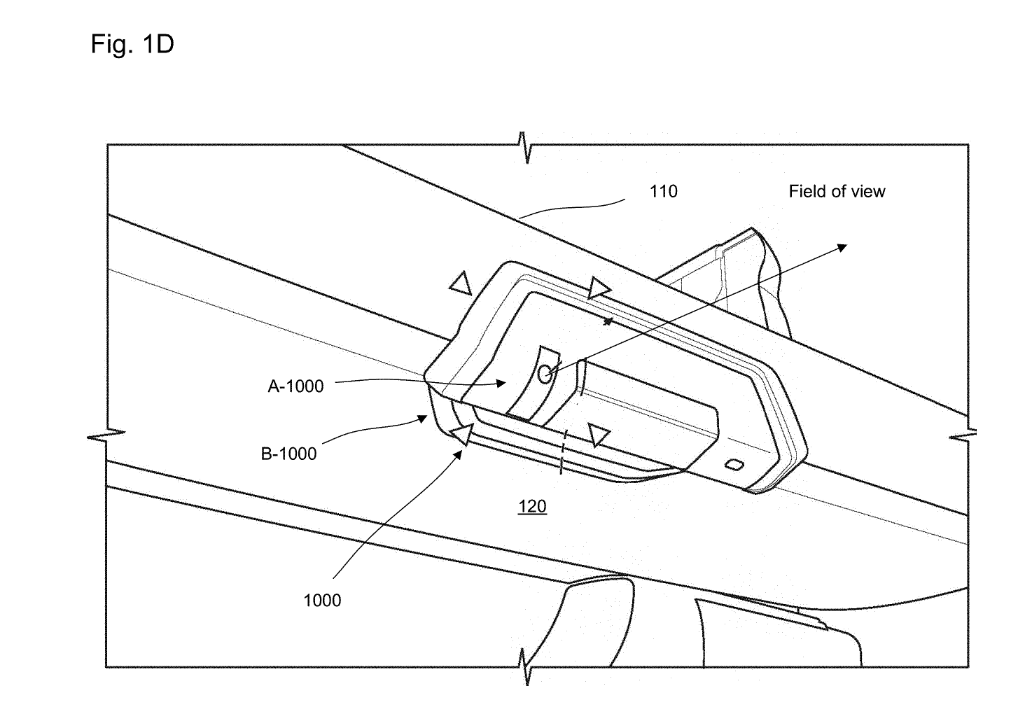

FIGS. 1A-1D are a perspective view of a vehicle 100 in an unloaded state, a perspective view of the vehicle 100 in a loaded state, a perspective view of an rear view camera system 1000 when the vehicle is in the unloaded state, and a perspective view of an rear view camera system 1000 when the vehicle is in the loaded state, according to certain aspects of the disclosure.

The vehicle 100 can be any type of vehicle configured and/or used to transport a cargo 200 that extends from a rear terminal portion of the vehicle 100, as illustrated in FIG. 1B. For example, the vehicle 100 can be a pick-up truck, an ultra-light to a medium truck, a transporter, or the like, and the cargo 200 can be any objects that protrudes from a rear portion of the vehicle 100 such as a canoe boat, as illustrated in FIG. 1B, timbers, beams, an off road vehicle, a bike, or the like.

The vehicle 100 can include a bed 110, a door 120 articulably affixed to the bed 110, and a handle 130 affixed to the door 120.

The bed 110 can receive the cargo 200 and provide a support surface 112 for the cargo 200.

The door 120 can be articulated between a closed position, as illustrated in FIG. 1A, and in an opened position, as illustrated in FIG. 1B, wherein in the closed position the door 120 partially closes the bed 110 and in the opened position the door 120 opens and extends the support surface 112 of the bed 110.

The handle 130 can be operated to unlock and lock the door 120 and allow the articulation of the door 120 between the opened position and the closed position, and vice-versa.

The rear view camera system 1000 can be positioned around the handle 130 and/or on an upper central portion of the door 120 to have centered and elevated field of view.

The rear view camera system 1000 can provide to a driver an unobstructed rear field of view of the vehicle 100 both when the vehicle 100 is in an unloaded state, e.g. without a cargo 200, as illustrated in FIG. 1A, and when the vehicle 100 is in a loaded state, e.g. with the cargo 200, as illustrated in FIG. 1B.

In addition, the rear view camera system 1000 can alert the other drivers, and/or pedestrians of the presence of the cargo 200 loaded on the vehicle 100.

The rear view camera system 1000 can include a camera unit A-1000, a light unit B-1000 that surrounds the camera unit A-1000, and an electrical control unit C-1000 operatively connected to the camera unit A-1000 and the electrical control unit C-1000.

The camera unit A-1000 can provide visibility towards a rear and substantially horizontal direction whether the vehicle 100 is in the loaded state or unloaded state to alleviate rear blind spots that can be present when the vehicle 100 is in the unloaded state or loaded state due to the cargo 200.

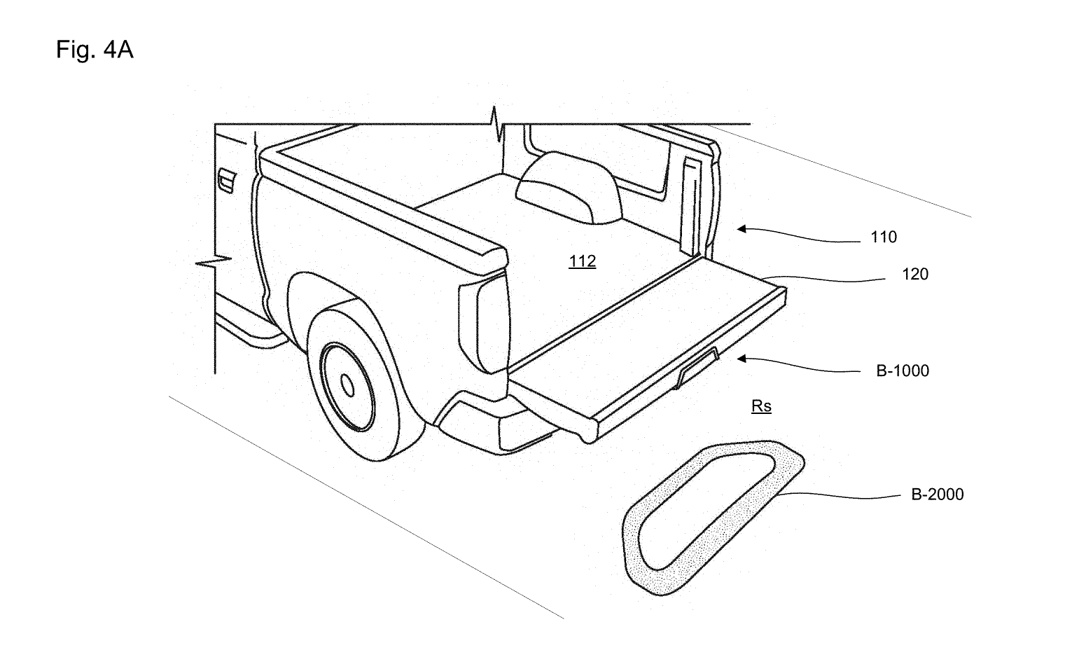

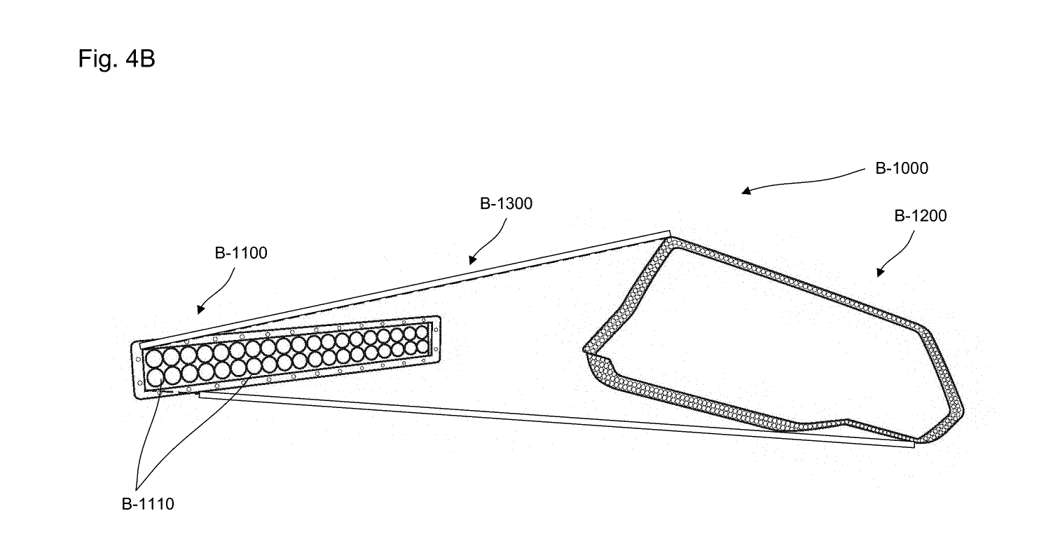

The light unit B-1000 can provide light signals B-2000 that can be projected onto a road surface Rs on which the vehicle 100 is supported, as illustrated in FIG. 4A.

The electrical control unit C-1000 can be configured to control the camera unit A-1000 and the light unit B-1000.

The different elements of the electrical control unit C-1000 as well as their interactions and functionality will be described in further details in the following paragraphs.

The camera unit A-1000 can be articulable in relation with the door 120 to be maintained substantially in a horizontal direction when the door is articulated between the closed position when the vehicle 100 is in the unloaded state, and the opened position when the vehicle 100 is in the loaded state. The articulation of the camera unit A-1000 in relation with the door 120 can provide a rear field of view from the vehicle 100 that is substantially horizontal whether the door 120 is in the closed position or in the opened position thus alleviated blind spots and/or obstructions generated by the cargo 200 in the loaded state.

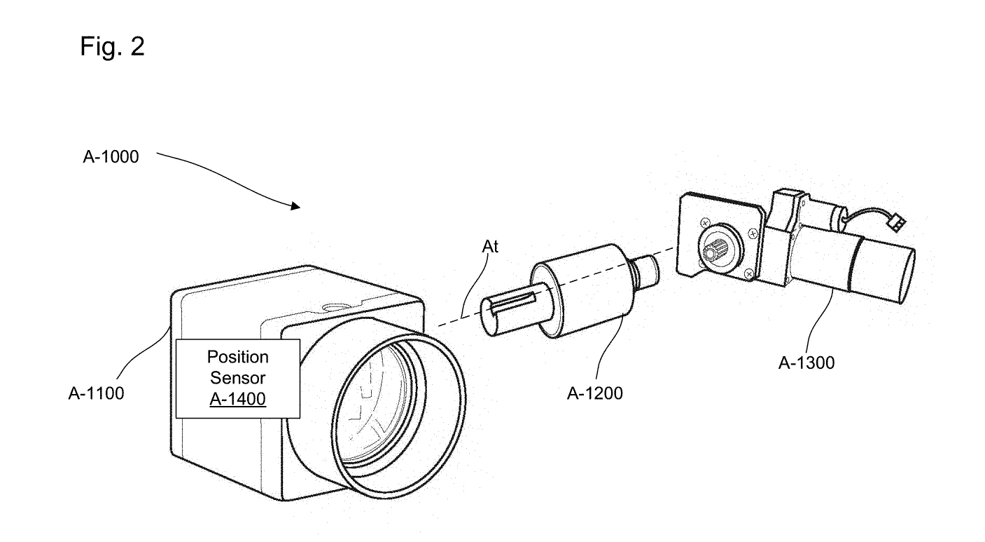

FIG. 2 is an exploded view of the camera unit A-1000 of the rear view camera system 1000, according to certain aspects of the disclosure.

The camera unit A-1000 can include a camera A-1100, a pivot A-1200 positioned substantially horizontally and affixed to the camera A-1000, a camera actuator A-1300 affixed to the camera A-1100, and a position sensor A-1400 operatively linked to the electrical control unit C-1000.

The camera A-1100 can be any type of video camera configured to provide to the electrical control unit C-1000 input video signals Svi commensurate with time series images in the rear direction of the vehicle 100. For example, the camera A-1100 can be a video camera equipped with wide-angle or fisheye lens.

The pivot A-1200 can provide rotation of the camera A-1100 around a transversal axis At to allow the camera A-1000 to be positioned substantially horizontally when the door 120 is articulated between the closed position and the opened position.

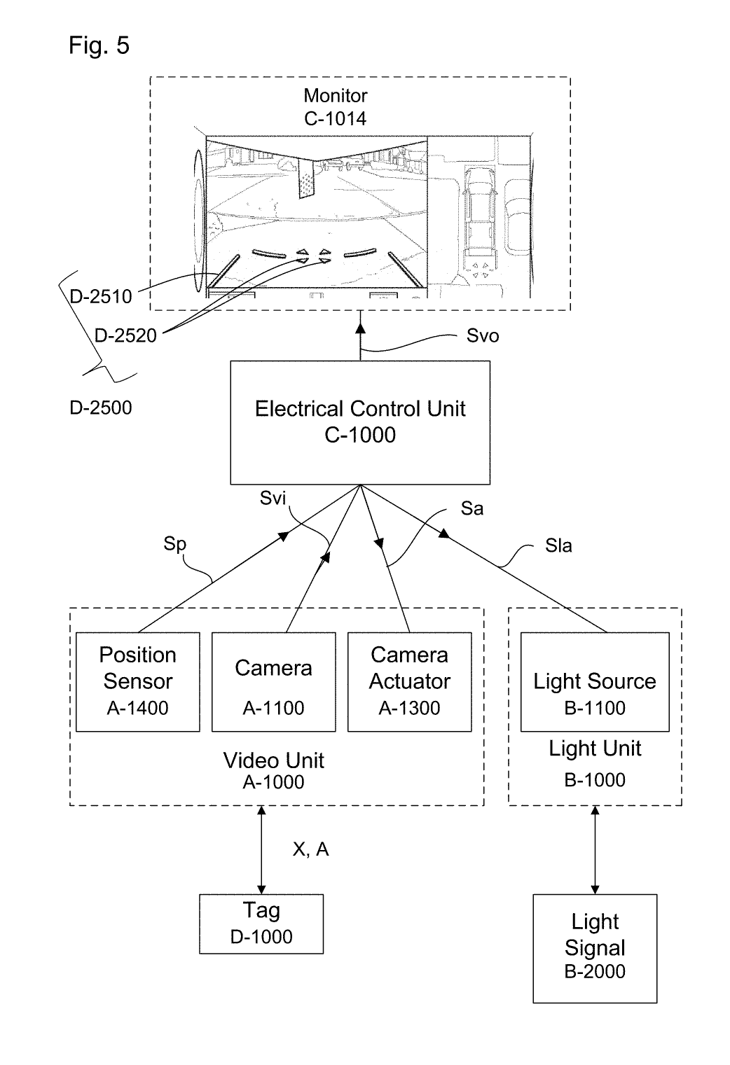

The camera actuator A-1300 can be any type of electrical actuators configured to receive actuation signals Sa from the electrical control unit C-1000, as illustrated in FIG. 5, and to provide rotation of the camera A-1100 around the transversal axis At. For example, the camera actuator A-1300 can be an electrical motor and/or an electrical servo actuator operatively connected to the electrical control unit C-1000 to receive the actuation signals Sa and rotate the camera C-1100 with a predetermined angle to maintain the rear field of view of the camera C-1100 substantially horizontal.

The position sensor A-1400 can be configured to provide to the electrical control unit C-1000 position signals Sp commensurate with a position of the door 120 between the closed position and the opened positioned, as illustrated in FIG. 5. For example, the position sensor A-1400 can be an angle sensor, e.g. Hall-effect angle sensor, configured to measure an inclination from a vertical direction, e.g. gravity direction, and/or a contact sensor linked to the handle 130 and/or a hinge of the door 120.

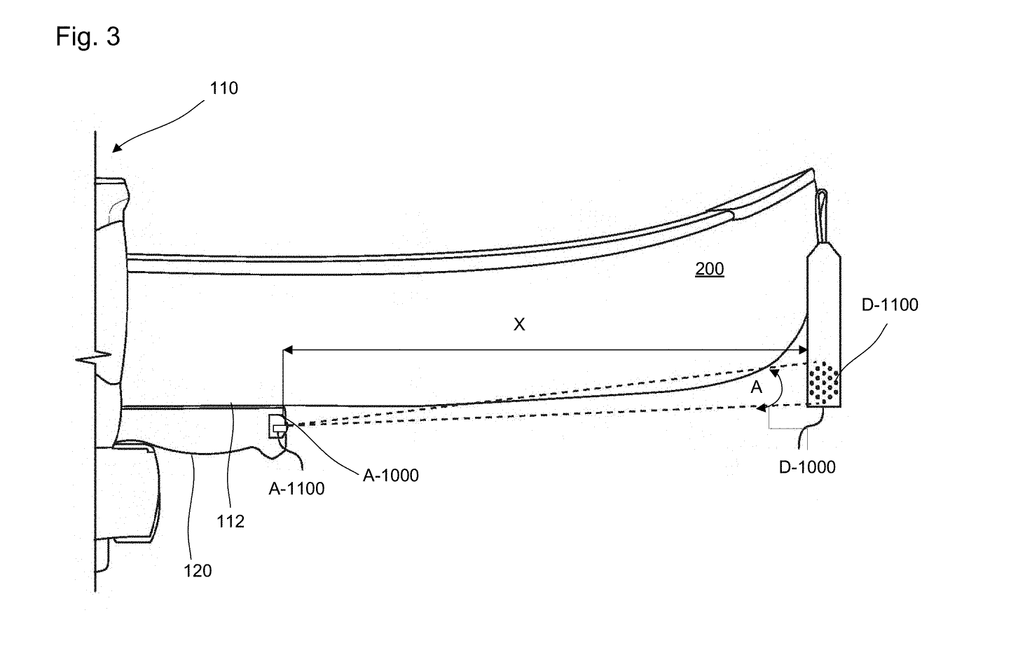

FIG. 3 is a side view of the vehicle 100 with a tag D-1000 of the rear view camera system 1000 when the vehicle 100 is in the loaded state, according to certain aspects of the disclosure.

The rear view camera system 1000 can also include a tag D-1000 that can be placed at a backward extremity of the cargo 200 to provide visual references that can be captured by the camera unit A-1000 and the electrical control unit C-1000 to provide positions and dimensions of a portion of the cargo 200 that protrudes from the vehicle 100.

The tag D-1000 can include makers D-1100 identifiable and detectable on the input video signal Svi provided by the camera A-1100 through software instructions executed on the electrical control unit C-1000. The markers D-1100 can be a plurality of dots with predetermined geometrical and/or visual characteristics, e.g. shape, color, pattern, or the like, configured to be visually detectable by software instructions executed on the electrical control unit C-1000, as well as attract attention to the driver, other drivers, and/or pedestrians. For example, the plurality of dots can be a plurality of white circular dots on a red background forming a pattern of concentric circles.

FIGS. 4A-4B are a perspective view of the light unit B-1000 projected light signals B-2000 and an exploded view of the light unit B-1000 of the rear view camera system 1000, according to certain aspects of the disclosure.

The light unit B-1000 can project the light signals B-2000 on the road surface Rs to increase the visibility of the driver as well as to attract the attention of other drivers and/or pedestrians on the cargo 200 that protrudes from the vehicle 100.

The light unit B-1000 can include a light source B-1100, a lens B-1200 that surrounds the handle 130 and/or the camera unit A-1000, and a light guide B-1300 positioned between the light source B-1100 and the lens B-1200.

The light source B-1100 can receive light actuation signals Sla from the electrical control unit C-1000 and generate light that is guided by the light guide B-1300 and goes through the lens B-1200 to diffuse the light signals B-2000 on the road surface Rs.

The light source B-1100 can be a plurality of light emitting diodes B-1110 (LED) independently or dependently controlled by the electrical control unit C-1000 to provide different light patterns and/or animations, e.g. flashing, light intensity variation, and/or the like, to the light signals B-2000 to further attract attention from other drivers and/or pedestrians.

In addition, the lens B-1200 can be configured to provide predetermined physical characteristics, e.g. shape, dimension, color, and/or the like, to the light signals B-2000 to further attract attention from other drivers and/or pedestrians.

FIG. 5 is schematic diagram of the rear view camera system 1000, according to certain aspects of the disclosure.

The electrical control unit C-1000 is configured to receive the positioning signals Sp commensurate with a position of the door 120 between the opened position and the closed position provided by the position sensor A-1400, the input video signals Svi commensurate with time series images of the rear field of view of the vehicle 100 provided by the camera A-1100, to provide the actuation signals Sa commensurate with a rotation of the camera A-1100 to the camera actuator A-1300, the light actuation signals Sla commensurate with the light signals B-2000 to the light source, and output video signals Svo commensurate with time series images to be displayed on a C-1014 of the electrical control unit C-1000.

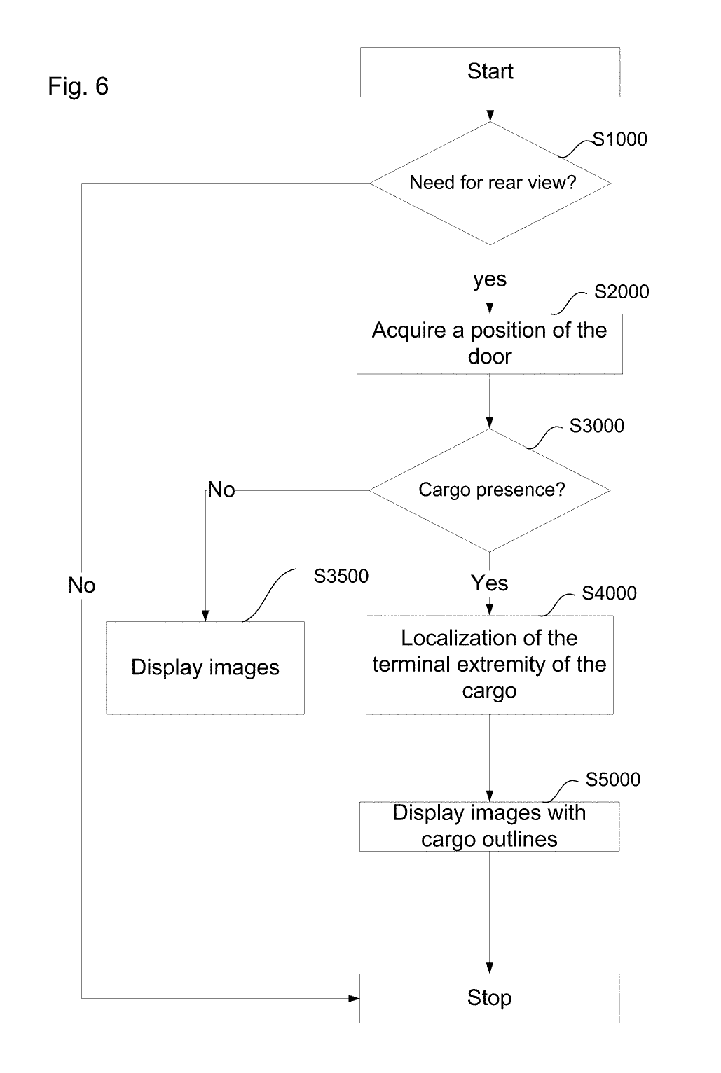

FIG. 6 is a chart flow of a method for operating the rear view camera system 1000, according to certain aspects of the disclosure.

In a step S1000, it is detected if a rear view is needed.

For example, the need of a rear view can be detected via software instructions executed on the electrical control unit C-1000. The electrical control unit C-1000 can be configured and the software instructions can be written to receive gear signals from a gear box of the vehicle 100 commensurate with a driving direction, and the need of rear view can be detected when the gear signals indicate a driving direction in the rear direction.

In another example, the electrical control unit C-1000 can be configured and the software instructions can be written to receive inputs from the driven indicating of a need of rear view. The inputs can be entered via a graphical user interface displayed on the monitor C-1014 of the electrical control unit C-1000 and/or via push buttons, switches, or the like, actuated by the driver.

If a rear view need is detected the process goes to a step S2000. Otherwise, the process stops.

In a step S2000, a position of the door 120 between the opened position and the closed position is acquired.

For example, the electrical control unit C-1000 can be configured and the software instructions can written to receive the position signals Sp from the position sensor A-1400, and extract a position, e.g. angle, of the door 120 between the closed position and the opened position.

In a step S3000, the presence of the cargo 200 on the bed 110 of the vehicle 100 is detected.

For example, the electrical control unit C-1000 can be configured and the software instructions can be written to receive the input video signals Svi from the camera A-1100 of the camera unit A-1000, and detect the presence of the tag D-1000 and/or the markers D-1100 in the input video signal Svi. The detection of the tag D-1000 and/or the markers D-1100 can be performed through image processing tools such as object and/or shape recognition, image segmentation, filtering, or the like.

If the presence of the cargo 200 is detected, the process goes to a step S4000. Otherwise, the process goes to a step S3500.

In the step S3500, the image commensurate with the input video signal Vs are displayed on the monitor C-1014 of the electrical control unit C-1000.

In the step S4000, a terminal extremity of the cargo 200 that protrudes from the vehicle 100 is localized.

For example, the electrical control unit C-1000 can be configured and the software instructions can be written to receive the input video signal Svi from the camera A-1100 and measure a distance X between the camera A-1100 and the tag D-1000 and/or the markers D-1100 as well as an angle A between the support surface 112 of the vehicle 100 and the tag D-1000 and/or the markers D-1100, as illustrated in FIG. 3. The measurement of the distance X and/or the angle A can be performed through image measuring tools such as scaling, triangulation, or the like.

In the step S5000, the input video signals Svi are modified to provide and display the output video signals Svo on the monitor C-1014 based on the position X and the angle A.

For example, visual guides D-2500 that frames and/or delimits a periphery of the cargo 200 can be superimposed to the input video signals Svi and displayed on the monitor C-1014. The visual guides D-2500 can be determined based on the localization of the terminal extremity of the cargo 200, e.g. the distance X and/or the angle A, as well as dimensions of the vehicle 100, e.g. width of the vehicle 100 and/or bed 110, to prevent the vehicle 100 from contacting obstacles, e.g. other vehicles, pedestrian, buildings, or any other type of structures, as illustrated in FIGS. 3 and 5.

For example, the visual guides D-2500 can be dashed and/or solid lines D-2510 that surrounds the cargo 200 and/or the vehicle 100, as illustrated in FIG. 5, and/or arrows D-2520 indicating the terminal extremity of the cargo 200 as illustrated in FIG. 5, and that are superimposed on images of the rear field of view of the vehicle 100.

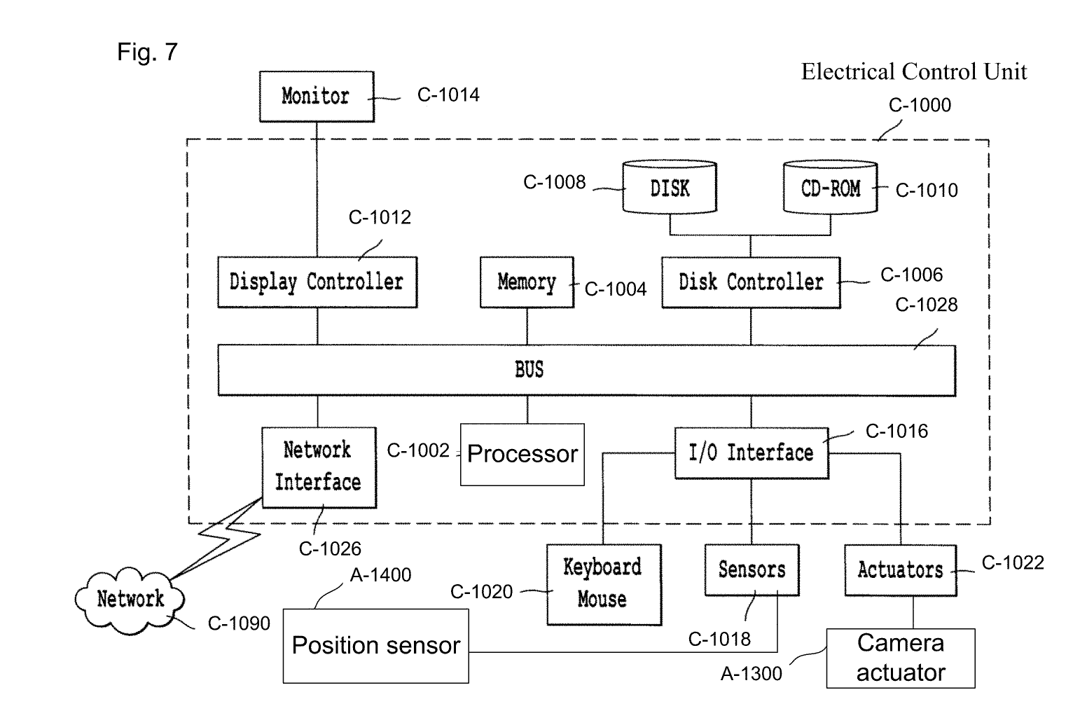

FIG. 7 is a schematic view of a hardware diagram of an electrical control unit C-1000 of the rear view camera system 1000, according to certain aspects of the disclosure.

FIG. 7 depicts the electrical control unit C-1000 to control the apparatus to draft a patent application. As shown in FIG. 7, systems, operations, and processes in accordance with this disclosure may be implemented using a processor C-1002 or at least one application specific processor (ASP). The processor C-1002 may utilize a computer readable storage medium, such as a memory C-1004 (e.g., ROM, EPROM, EEPROM, flash memory, static memory, DRAM, SDRAM, and their equivalents), configured to control the processor C-1002 to perform and/or control the systems, operations, and processes of this disclosure. Other storage mediums may be controlled via a disk controller C-1006, which may control a hard disk drive C-1008 or optical disk drive C-1010.

The processor C-1002 or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The processor C-1002 may be a separate device or a single processing mechanism. Further, this disclosure may benefit form parallel processing capabilities of a multi-cored processor.

In another aspect, results of processing in accordance with this disclosure may be displayed via a display controller C-1012 to a monitor C-1014 that may be peripheral to or part of the vehicle 100, e.g. positioned and/or integrated to a dashboard of the vehicle 100. Moreover, the monitor C-1014 may be provided with a touch-sensitive interface to a command/instruction interface. The display controller C-1012 may also include at least one graphic processing unit for improved computational efficiency. Additionally, the electrical control unit C-1000 may include an I/O (input/output) interface C-1016, provided for inputting sensor data from sensors C-1018 and for outputting orders to actuators C-1022. The sensors C-1018 and actuators C-1022 are illustrative of any of the sensors and actuators described in this disclosure. For example, the sensors C-1018 can include the position sensor A-1400, while the actuators C-1022 can include the camera actuator A-1300.

Further, other input devices may be connected to an I/O interface C-1016 as peripherals or as part of the controller C-1000. For example, a keyboard or a pointing device such as a mouse C-1020 may control parameters of the various processes and algorithms of this disclosure, and may be connected to the I/O interface C-1016 to provide additional functionality and configuration options, or to control display characteristics. Actuators C-1022 which may be embodied in any of the elements of the apparatuses described in this disclosure may also be connected to the I/O interface C-1016.

The above-noted hardware components may be coupled to the network C-1024, such as the Internet or a local intranet, via a network interface C-1026 for the transmission or reception of data, including controllable parameters to a mobile device. A central BUS C-1028 may be provided to connect the above-noted hardware components together, and to provide at least one path for digital communication there between.

The foregoing discussion discloses and describes merely exemplary embodiments of an object of the present disclosure. As will be understood by those skilled in the art, an object of the present disclosure may be embodied in other specific forms without departing from the spirit or essential characteristics thereof. Accordingly, the present disclosure is intended to be illustrative, but not limiting of the scope of an object of the present disclosure as well as the claims.

Numerous modifications and variations on the present disclosure are possible in light of the above teachings. It is therefore to be understood that within the scope of the appended claims, the disclosure may be practiced otherwise than as specifically described herein.

What is claimed is:

1. A camera system for a vehicle, comprising:
a camera attached to a door of the vehicle to provide a rear field of view of the vehicle, the camera being articulable between an opened position and a closed position;
an actuator affixed to the camera to rotate the camera;
a position sensor that detects a position of the door between the opened position and the closed position; and
an electrical control unit configured to operate the camera actuator based on the position detected by the position sensor such that the rear field of view is substantially directed in a horizontal direction.

2. The camera system of claim 1, wherein the electrical control unit is further configured to detect a periphery of a cargo loaded on the vehicle with the camera.

3. The camera system of claim 2, wherein the electrical control unit is further configured to detect a distance between an extremity of the cargo.

4. The camera system of claim 3, wherein the electrical control unit is further configured to display on a monitor visual guides based on at least one of the periphery of the cargo and the extremity of the cargo.

5. The camera system of claim 4, wherein the visual guides are lines superimposed to the rear field of view of the vehicle.

6. The camera system of claim 2, further comprises:
a tag affixable to an extremity of the cargo,
wherein the detection of the periphery of the cargo is determined by the electrical control unit by the camera detecting the tag.

7. The camera system of claim 6, wherein the tag includes markers to indicated the extremity of the cargo.

8. The camera system of claim 7, wherein the markers are a plurality of dots arranged in concentric circle.

9. The camera system of claim 1, wherein the camera unit is positioned in an upper portion of the door.

10. A camera system for a vehicle, comprising:
a camera attached to a door of the vehicle to provide a rear field of view of the vehicle, the camera being articulable between an opened position and a closed position;
an actuator affixed to the camera to rotate the camera;
a position sensor that detects a position of the door between the opened position and the closed position;
a light unit that surrounds the camera unit; and
an electrical control unit configured to
activate the light unit to project light on a road surface when the door is in the opened position as detected by the position sensor, and
operate the camera actuator based on the position detected by the position sensor such that the rear field of view is substantially directed in a horizontal direction.

11. The camera system of claim 10, wherein the light projected on the road by the light unit has a predetermined light-shape to indicated that the vehicle is moving backward.
